(19) United States
(12) Patent Application Publication
(10) Pub. No.: US 2009/0166334 A1
(43) Pub. Date: Jul. 2, 2009

(54) Microshaft Forming Method, Microshaft Formed by This Method and Microshaft Forming Apparatus

(75) Inventors: Naotake Mohri, Tokyo (JP); Takayuki Tani, Ibaraki (JP)

Correspondence Address: HARNESS, DICKEY & PIERCE, P.L.C., P.O. BOX 828, BLOOMFIELD HILLS, MI, 48303, US

(73) Assignees: The University of Tokyo, Tokyo (JP); National University Corporation Tsukuba University of Technology, Tsukuba-shi (JP)

(21) Appl. No.: 12/084,995

(22) PCT Filed: Nov. 9, 2006
(86) PCT No.: PCT/JP2006/322351

§ 371 Date: May 14, 2008

(30) Foreign Application Priority Data
Nov. 16, 2005 (JP) 2005-331656

(51) Int. Cl. B23H 1/04; B23H 1/00; B23H 9/00

(52) U.S. Cl. 219/69.15; 219/69.12; 219/69.17

(57) ABSTRACT

A microshaft forming method and apparatus for forming a microshaft without requiring high level of stillness required by conventional methods. The microshaft forming apparatus comprises an elongated electrode (1) to be formed into a microshaft, a forming plate (3) for forming the electrode (1), electrode rotating means for rotating the electrode (1) around the length direction (1a) of the electrode (1), a discharge machining power supply (5) for applying a voltage between the electrode (1) and the forming plate (3) to cause discharge between the electrode (1) and the forming plate (3), and electrode moving means for traversing the electrode (1) rotated by the electrode rotating means across the forming plate (3) from the side edge surface (3a) of the forming plate (3). When the electrode moving means is operated, a groove (3b) is formed in the forming plate (3) by using the discharge caused between the electrode (1) and the forming plate (3) by the discharge machining power supply (5) to form the electrode (1) into a microshaft.

### FIELD OF THE INVENTION

The present invention relates to a method and an apparatus for forming a microshaft used for electric discharge machining and more particularly, to a microshaft formation using an electric discharge phenomenon to a scanning and rotating electrode shaft with a plate member serving as a counter electrode.

### DESCRIPTION OF THE PRIOR ART

The electric discharge machining method representative of the non-contact machining technique, characterized in its small reactive force during machining, is effective in the field of microfabrication which requires fine tools. The methods for forming a microshaft to be used for the micro electric discharge machining include: (1) the inverse electric discharge method; (2) the wire electro discharge grinding method (hereinafter referred to as WEDG method); (3) the electric discharge microshaft forming method using a hole; (4) the repeated transcriptional micro electric discharge machining method; (5) the fine fabrication by means of a zinc electrode; and (6) the microshaft instantaneous forming method of a fine electrode using a single-shot of electric discharge, respectively, as shown in FIG. 21.

The microshafts formed in the above methods are useful for a measuring probe for measurement of a fine configuration and/or a surface roughness, a tool for micro manipulation, a fine hole forming tool for forming a fine hole, such as a nozzle hole, a two- or three-dimensional fine configuration creating tool for a fine mold. Especially, the inverse electric discharge machining method representing a non-contact machining technique is characterized in its small reactive force and thus allows a microshaft to be produced easily. In addition, since the inverse electric discharge machining method allows a forming shaft that has been formed in a machining apparatus to be used as a tool for carrying out a subsequent step of processing in the same apparatus without any re-chucking operation, therefore the method has become a standard machining process.

### REFERENCE

[Patent document 1]

Japanese Laid-open Publication No. 2004-142087

### DISCLOSURE OF THE INVENTION

### Problem to be Solved by the Invention

The WEDG method is one representative method as the microshaft forming method that takes advantage of the electric discharge machining which uses a running wire made of brass as a tool, as shown in FIG. 21(3). Although this method, owing to its capability for producing a microshaft of high precision easily, has become a standard of technique, the method has been yet suffered from defects that it requires a long forming time and that asymmetrical electric discharge occurs with respect to a side surface of the shaft and consequently the shaft with such a shaft diameter as minute as some microns or smaller is inescapable from the effect of vibration.

Besides, there is one approach in order to achieve a symmetrical electric discharge, in which a microshaft is formed in a certain type of machining process, such as a reciprocal abrasion, while using the shaft as a tool for making a hole in a plate (see FIG. 21(3) as well as the document 1). In this case, since a primary scanning direction of a shaft is normal to a top surface of the plate, disadvantageously this approach could not control a microshaft diameter and a microshaft length to be produced, independently from each other. Therefore, the approach requires a large set of experimental data in order to achieve a target shaft diameter or a target shaft configuration. Although there may be another approach contemplating the swinging of the shaft relative to a previously formed hole, it must encounter a problem of making an initial hole or another problem, such as the processing time and the shaft vibration, as is the case with the WEDG method.

From the reasons above, the machining process according to the prior art technique requires a high level of practice and skill but is not favorable for mass production, consequently turning out not to be as popular as it has been initially expected. This is a remote cause that the microfabrication has sunk in the death valley.

In the light of the above situation, an object of the present invention is to provide a microshaft forming method and a microshaft forming apparatus by way of an electrode scanning method, which is capable of forming a microshaft efficiently without the need for acquiring a high level of practice and skill as is the case with the conventional methods.

### Means to Solve the Problem

The present invention has been made to solve the problems as pointed above and a first invention provides a method for forming a microshaft, characterized in comprising: a step of providing an electrode to be processed into the microshaft; a step of providing a forming member for shaping the electrode; an electrode rotation step for rotating the electrode around a rotation center extending longitudinally through the electrode; a power supplying step for supplying a power to the electrode and to the forming member by using a discharge machining power supply in order to induce electric discharge between the electrode and the forming member; an electrode moving step for moving the electrode, as it is in a rotational motion by the electrode rotation step, from a lateral end side of the forming member transversely across the forming member; and a microshaft formation step for shaping the electrode to be formed into the microshaft, while forming a groove in the forming member during the electrode moving step by using the electric discharge induced between the electrode and the forming member by the power supplying step.

A second invention provides a method for forming a microshaft as defined by the first invention, characterized in further comprising, before the electrode moving step, a slit formation step for forming a slit previously in the forming member along a direction for the electrode to be moved. A third invention provides a method for forming a microshaft as defined by the second invention, characterized in that the forming member comprises two forming members and the slit is formed as a gap between the two forming members.

A fourth invention provides a method for forming a microshaft as defined by the third invention, characterized in that the two forming members are electrically isolated from each other. A fifth invention provides a method for forming a microshaft as defined by the third invention, characterized in that the two forming members are electrically connected with each other.

A sixth invention provides a method for forming a microshaft as defined by any one of the first to the fifth inventions, characterized in that, during the electrode moving step, a secondary motion is applied to the electrode in a direction different from the direction of the electrode moving from the lateral end side of the forming member transversely across the forming member.

A seventh invention provides a method for forming a microshaft as defined by the sixth invention, characterized in that the secondary motion is a reciprocating motion of the electrode in a direction vertical to a top surface of the forming member. An eighth invention provides a method for forming a microshaft as defined by the sixth invention, characterized in that the secondary motion is a reciprocating motion of the electrode in an angled direction relative to a top surface of the forming member.

A ninth invention provides a method for forming a microshaft as defined by any one of the first to the fifth inventions, characterized in that, during the electrode moving step, the electrode is driven to make a swing motion relative to the forming member in a direction parallel to a top surface of the forming member.

A tenth invention provides a method for forming a microshaft as defined by any one of the third to the fifth inventions, characterized in further comprising: a discharge frequency measurement step for measuring discharge frequencies between the electrode and each of the two forming members; and a discharge frequency control step for controlling the discharge frequencies measured in the discharge frequency measurement step so that the discharge frequencies are equal to each other.

An eleventh invention provides a method for forming a microshaft as defined by the tenth invention, characterized in that the discharge frequency control step comprises a distance control means for controlling distances between each of the two forming members and the electrode to be equal to each other. A twelfth invention provides a method for forming a microshaft as defined by the tenth or the eleventh invention, characterized in that the discharge frequency measurement step is a current detection step for detecting current flowing to each of the two forming members.

A thirteenth invention provides a method for forming a microshaft as defined by any one of the third to the fifth inventions or the tenth to the twelfth inventions, characterized in further comprising, before said electrode moving step, a slit discharge machining step for performing previously the electric discharge machining between the two forming members so as to shape an inner surface of the slit.

A fourteenth invention provides a method for forming a microshaft as defined by any one of the first to the thirteenth inventions, characterized in further comprising: after the microshaft formation step, a groove width adjustment step for narrowing the groove of the forming member; and after the groove width adjustment step, a reprocessing step for performing a series of operations comprising the electrode rotation step, the power supplying step, the electrode moving step and the microshaft formation step, in a sequential manner. A fifteenth invention provides a method for forming a microshaft as defined by the fourteenth invention, characterized in that the reprocessing step is repeated by multiple times.

A sixteenth invention provides a microshaft characterized in that the microshaft is formed from the electrode by using a method for forming a microshaft as defined by any one of the first to the fifteenth inventions.

A seventeenth invention provides an apparatus for forming a microshaft, characterized in comprising: an electrode to be processed into said microshaft; a forming member for shaping the electrode; an electrode rotation means for rotating the electrode around a rotation center extending longitudinally through the electrode; a discharge machining power supply for supplying power to the electrode and to the forming member in order to induce electric discharge between the electrode and the forming member; and an electrode moving means for moving the electrode, as it is in a rotational motion driven by the electrode rotation means, from a lateral end side of the forming member transversely across the forming member, wherein during operation of the electrode moving means, the electrode is shaped to form the microshaft while forming a groove in the forming member by using the electric discharge induced between the electrode and the forming member by the discharge machining power supply.

An eighteenth invention provides an apparatus for forming a microshaft as defined by the seventeenth invention, characterized in that the forming member comprises a slit that is previously formed in the forming member along a direction for the electrode to be moved. A nineteenth invention provides an apparatus for forming a microshaft as defined by the eighteenth invention, characterized in that the forming member comprises two forming members and the slit is formed as a gap between the two forming members.

A twentieth invention provides an apparatus for forming a microshaft as defined by the nineteenth invention, characterized in further comprising a frequency measurement means for measuring discharge frequencies between the electrode and each of the two forming members; and a discharge frequency control means for controlling the discharge frequencies measured by the discharge frequency measurement means so that the discharge frequencies are equal to each other.

A twenty-first invention provides a method for forming a microshaft as defined by any one of the first to the fifteenth invention, characterized in that the forming member employs a forming member made of silicon.

A twenty-second invention provides a method for forming a microshaft as defined by the twenty-first invention, characterized in that electric discharge is induced between the electrode and the forming member made of silicon, so that a silicon contained layer is formed over a surface of the microshaft while the microshaft is being formed.

A twenty-third invention provides a microshaft characterized in comprising the silicon contained layer formed over the surface of the microshaft by a method for forming a microshaft as defined by the twenty-first or the twenty-second invention.

### BRIEF DESCRIPTION OF THE DRAWINGS

FIG. 1 is a conceptual side elevational view illustrating a microshaft forming method according to a first embodiment of the present invention;

FIG. 2 is a perspective view illustrating processing being carried out by the microshaft forming method of FIG. 1;

FIG. 3 is a schematic block diagram of an electric discharge machining apparatus used for electric discharge machining of the present invention;

FIG. 4 is a graph indicating a transition of shaft diameter of an electrode as a function of a processing time in the microshaft forming method of FIG. 1;

FIG. 5 shows a condition of an electrode that has been processed under a processing condition of Table 1;

FIG. 6 is a graph indicating a transition of shaft diameter of an electrode as a function of a processing time for different members in the microshaft forming method of FIG. 1;

FIG. 7 is a graph showing a discharge voltage waveform during processing with a zinc alloy and a cemented carbide, respectively;

FIG. 8 is a conceptual top view illustrating a microshaft forming method according to a second embodiment of the present invention;

FIG. 9 is a perspective view showing processing being carried out by the microshaft forming method of FIG. 8;

FIG. 10 is a perspective view illustrating a microshaft forming method according to a third embodiment of the present invention;

FIG. 11 is a perspective view illustrating a microshaft forming method according to a fourth embodiment of the present invention;

FIG. 12 is a perspective view illustrating a microshaft forming method according to a fifth embodiment of the present invention;

FIG. 13 shows a condition of an electrode that has been processed by scanning in a diagonally upward direction;

FIG. 14 is a perspective view illustrating a microshaft forming method according to a sixth embodiment of the present invention;

FIG. 15 is a perspective view illustrating a microshaft forming method according to a seventh embodiment of the present invention;

FIG. 16 shows a condition of an electrode that has been processed to form a stepped microshaft by the microshaft forming method of FIG. 15;

FIG. 17 is a perspective view of a first additional embodiment of the present invention;

FIG. 18 is a perspective view of a second additional embodiment of the present invention;

FIG. 19 is a graph indicating a radius of an electrode shaft as a function of a processing time under a condition where a serve voltage being switched over the processing time;

FIG. 20 shows a microshaft that has been formed from an electrode by the second additional embodiment;

FIG. 21 shows representative forming methods of a microshaft according to the prior art;

FIG. 22 shows a certain phase of electric discharge machining according to an embodiment of the present invention;

FIG. 23 presents (a) a discharge waveform diagram for an Si electrode and (b) a discharge waveform diagram for a BS electrode, respectively, during electric discharge machining according to an embodiment of the present invention;

FIG. 24 is a side elevational view showing a micro linear-shaft that has been processed and formed by an embodiment of the present invention;

FIG. 25 represents a corrosion experiment on a micro linear shaft obtained from an embodiment of the present invention, wherein (a) shows a condition before being eroded by a hydrochloric acid and (b) shows a condition after having been eroded by the hydrochloric acid;

FIG. 26 is a plot indicating a transition of diameter as a function of a corrosion time in the corrosion experiment of FIG. 25;

FIG. 27 is a plot representing a surface roughness profile of an Si electrode and a BS electrode, respectively, obtained from an embodiment of the present invention; and

FIG. 28 represents a SEM image and a result from an EDS analysis for an Si electrode obtained from an embodiment of the present invention.

Components in the attached drawings are designated as follows:

1 Electrode

1a Rotation axis

1b Microshaft

3 Forming plate

3a End surface

3b Slit

3c Groove

5 Discharge machining power supply

7 Scanning direction (Electrode moving direction)

9 Electric discharge machining apparatus

11 Carrier stage

12a, 12b, 12c Stepping motor

15 Drive clock controller

16 Working fluid level

17 Video microscope

18 Personal computer

19 Driver

21 Averaging circuit

23 Comparator

27 Discharge deviation detecting circuit

27a Current detector

33 Forming plate

33a End surface

33b Slit

33c Groove

### BEST MODE FOR CARRYING OUT THE INVENTION

Respective embodiments according a microshaft forming method and a microshaft forming apparatus by way of an electrode scanning method of the present invention will now be described with reference to the attached drawings. It is to be noted that in the drawings, like elements are designated by using the same reference numerals and any descriptions on the like elements are omitted.

### First Embodiment

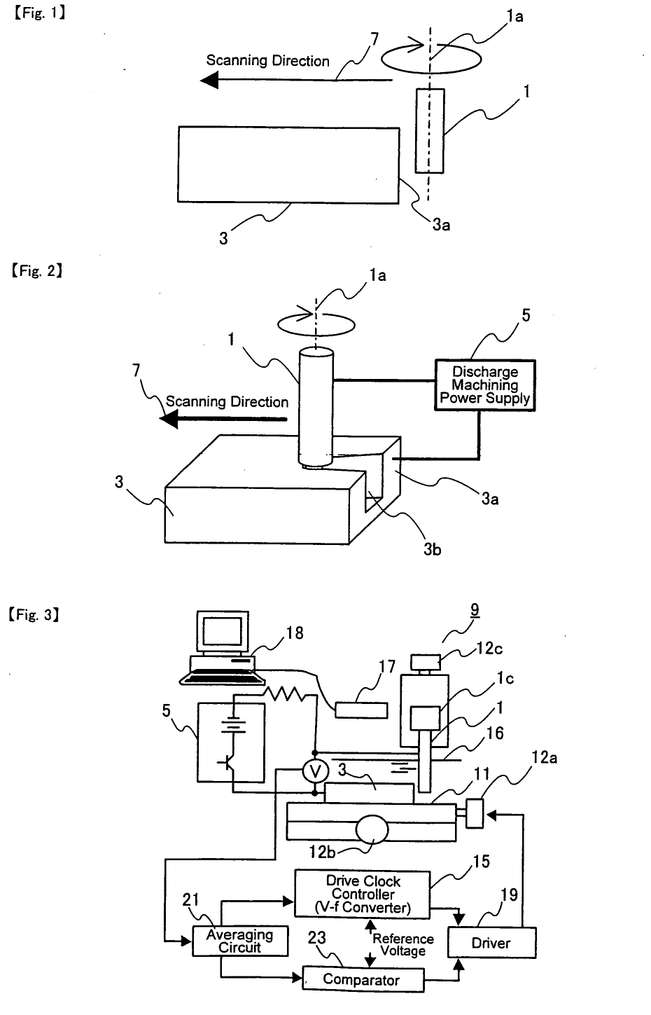

A first embodiment provides a microshaft forming method according to a “direct scanning method”. In the conceptual diagram as shown in FIG. 1, an elongated cylindrical forming electrode 1 (i.e., a scanning and rotating shaft) is disposed so that it can be rotated around a center 1a extending axially (longitudinally) by means of a rotating mechanism which is not shown and also it can be moved horizontally by means of an electrode scanning and moving mechanism which is not shown. A forming plate (forming member) 3, which is preferably a flat plate having a thickness around some mm or thinner, is fixedly and horizontally disposed in a lateral side with respect to the electrode 1.

FIG. 2 shows the electrode 2 during being processed with the electric discharge machining operation within the forming plate. As shown in FIG. 2, the electrode 1 and the forming plate 3 are connected with a discharge machining power supply 5, respectively, in order to induce electric discharge between the electrode 1 and the forming plate 3. This allows a discharge voltage from the discharge machining power supply 5 to be applied and thus the electric discharge to occur between the electrode 1 and the forming plate 3. With this electric discharge condition maintained, the electrode 1 is moved, while being rotated, from a lateral end surface 3a of the plate 3 toward an inner side of the plate 3 along a scanning direction 7 parallel to a top surface of the forming plate 3 transversely across the forming plate 3. The electrode 1 and the forming plate 3 are abraded and resultantly a groove 3b is formed in the forming plate 3 by the electric discharge during the scanning. On the other hand, although the electrode 1 is also abraded by the electric discharge during this scanning, the electrode 1 can be shaped to form a microshaft, as the electrode 1 is being rotated and thus abraded to be narrower uniformly along a circumference of the electrode 1.

FIG. 3 shows a conceptual diagram of an electric discharge machining apparatus 9 to be used for such a processing as described above. The electric discharge machining apparatus 9 has a carrier stage 11 on which the forming plate 3 is placed horizontally. The carrier stage 11 is driven in the X-axial direction by a stepping motor 12a, in the Y-axial direction by a stepping motor 12b and in the Z-axial direction (the up and down direction in FIG. 3) by a stepping motor 12c. Further, the electrode 1 is disposed so that it can be rotated above the carrier stage 11 by an electrode rotating mechanism 1c around a rotation center extending along an axial direction 1a of the mechanism 1c.

As shown in FIG. 3, the voltage applied between the electrode 1 and the forming plate 3 is averaged in an averaging circuit 21 and input to a drive clock controller (V-f converter) 15 and a comparator 23. During the electric discharge machining operation, a drive clock of each stepping motor is controlled by the drive clock controller 15 in order to achieve the operation equivalent to that by a servo motor. In addition, the electric discharge machining apparatus 9 is provided with a video microscope 17 capable of providing a microshaft observation and a microshaft diameter measurement on the machining apparatus 9 in order to facilitate a measurement of the processed microshaft. The video microscope 17 is installed at a location enabling an image taking of the microshaft during or after processing by the machining apparatus 9. Further, an image from the video microscope 17 was presented on a display of a personal computer 18, so that the observation of the electrode 1 (microshaft) in the course of or after the processing was carried out for evaluation of the shaft diameter and configuration of the electrode 1. It is to be noted that an environment enclosing and surrounding the electrode 1 and the working plate 3 is arranged below a working fluid level 16 in order to facilitate the electric discharge.

An exemplary processing condition of the electrode 1 by the electric discharge machining apparatus 9 is presented in Table 1. The electrode 1 employed a cemented carbide of Ø 500 micrometer and the forming plate 3 employed a zinc alloy (ZAPREC), a brass and the S50C and a cemented carbide, which are expected to bring a stability in processing.

TABLE 1
Processing condition

| | |
|---|---|
| Electrode (microshaft) | Cemented carbide (ø 0.5) |
| Forming plate | Zinc alloy (ZAPREC), Brass, |
| | S50C, Cemented carbide |
| Electrode polarity | Positive |
| Current value | 0.6 A |
| Pulse width | 2 microsecond |
| Duty factor | 20% |
| No-load voltage | 80 V |

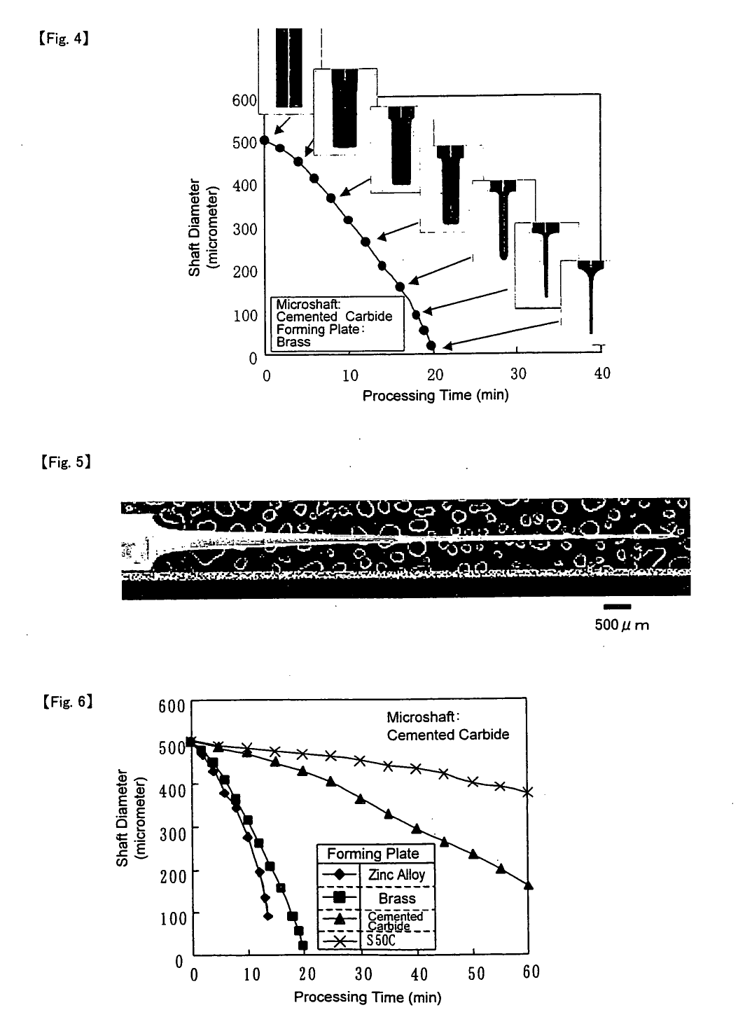

The process of forming the microshaft could be observed from a transition of shaft diameter of the electrode 1 as a function of a processing time as shown in FIG. 4. The shaft diameter of the electrode 1 was measured from the image captured by the vide microscope 17. The measurement is represented by an average value from 3 locations and a resolution used was 3 micrometer/pixel. FIG. 4 also contains the processed shaft configurations at each different processing time. The forming plate 3 used was one made of brass. The shaft diameter of the electrode 1 became narrower over the processing time and the shaft having a diameter of 500 micrometer was formed into the microshaft having a diameter of about 20 micrometer within a processing time around 20 minutes. Accordingly, if the processing is executed under a predetermined condition and the relationship between the processing time and the shaft diameter or between the scanning distance and the shaft diameter is previously established on the database, then a desired shaft diameter should be obtained in the method of the present invention. FIG. 5 shows a result from the observation of the electrode that has been processed under the processing condition as designated above.

Research was then made on an effect of the specific material of the forming plate 3 to a forming characteristic of the microshaft formed from the electrode 1. FIG. 6 indicates results from the processing obtained by using different materials for the forming plate 3, including the zinc alloy, the brass, the S50C and the cemented carbide, respectively. The forming rate of the microshaft was revealed higher for the zinc alloy and the brass followed by the cemented alloy and then the S50C.

To investigate the reason for the results, discharge voltage waveforms during the processing by the zinc alloy and the cemented carbide were observed, results from which observation are shown in FIG. 7. In the processing with the cemented carbide, there were observed a lot of short-circuits, exhibiting an intermittent discharging, while on the other hand, in the processing with the zinc alloy, there was almost no short-circuit, exhibiting a significantly high electric discharge frequency. The similar tendency was observed with the brass, and conceivably the difference in electric discharge frequency should affected to the forming rate of the shaft.

### Second Embodiment

A second embodiment provides a method and an apparatus for forming a microshaft using a “plate with a slit”. Even if the processing is executed under the predetermined condition and the relationship between the processing time and the shaft diameter or between the scanning distance and the shaft diameter is previously established on the database, as in the first embodiment, there will still be a case that makes it difficult to obtain a desired electrode diameter with good reproducibility, because in the electric discharge machining, the condition of the electric discharge varies depending on the condition of the working fluid and the specific electrode material or forming plate material. Possibly the case that makes it difficult to apply the method of the first embodiment is more likely to occur especially with a narrower electrode diameter.

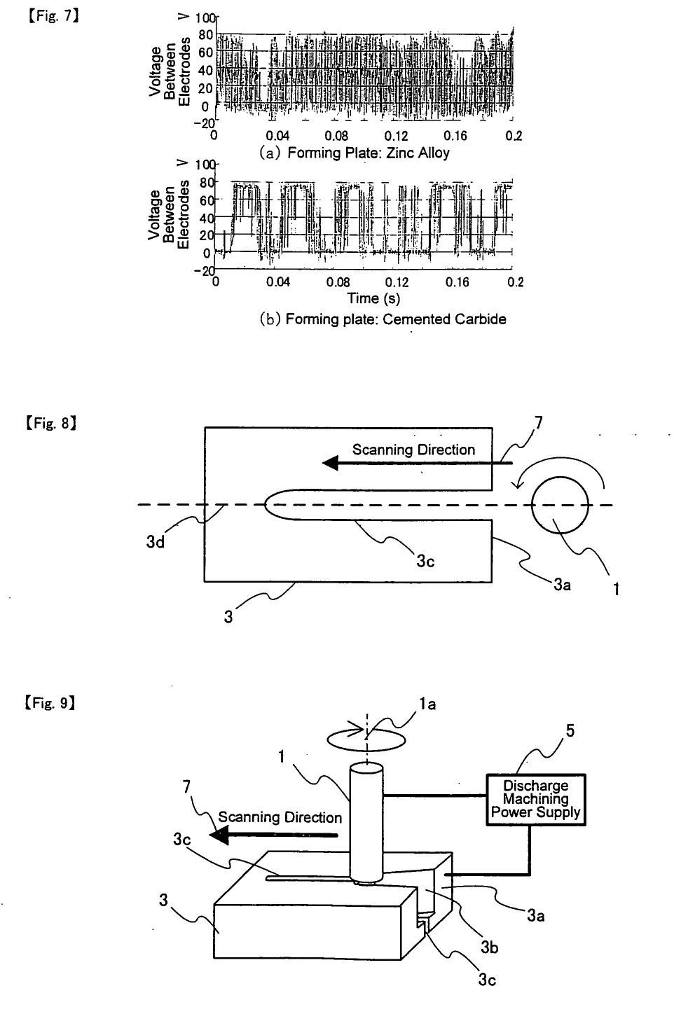

To address the problem above, in the processing method of the second embodiment, a forming plate 3 having a thickness around some mm or thinner is processed for slitting by way of the wire electric discharge machining so as to form a slit 3c previously in the forming plate 3, as shown in FIG. 8. Further, as seen from FIG. 8, an electrode 1 is driven, as in the rotating motion, to scan along a central surface 3d of the slit 3c, similarly to the step in the first embodiment. Then, the processing of the electrode 1 was carried out by scanning of the electrode 1 toward the inner side of the forming plate 3. In this case, it was possible to obtain a microshaft having a shaft diameter corresponding to a width of the slit 3c.

### Third Embodiment

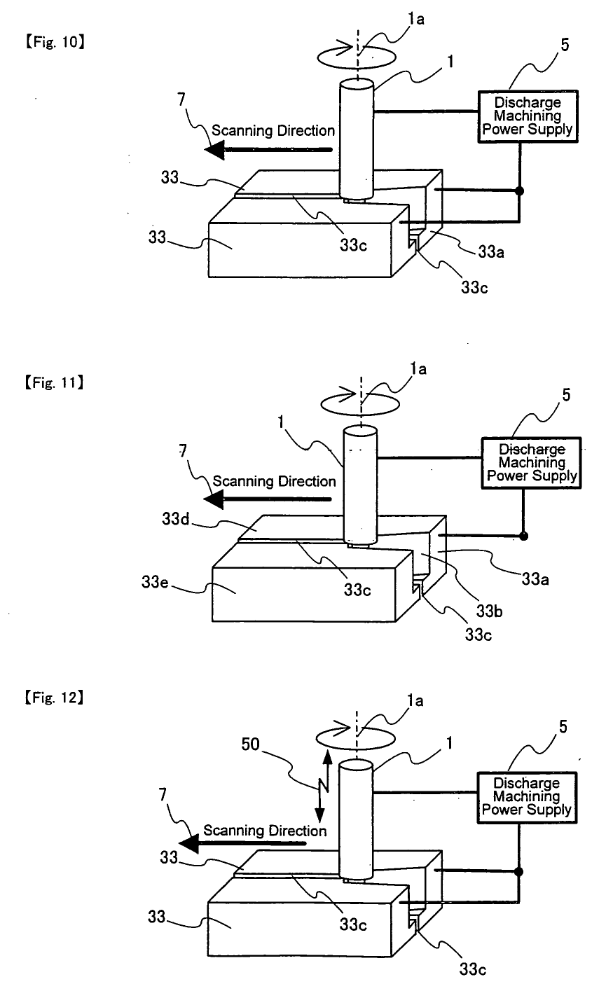

A third embodiment provides a method and an apparatus for forming a microshaft according to a “slit forming plate comprising a set of two plates”. The “slit forming plate comprising a set of two plates” refers to a set of two forming plates 33, each having a thickness of some mm or thinner, which are fixedly positioned with side surfaces of the two plates 33 close to each other in a parallel relationship so that a slit (a gap) 33c is defined therebetween, as shown in FIG. 10. In addition, two forming plates 33 are electrically interconnected and have the same potential.

Then, a forming electrode 1 is driven to scan from a groove end surface 33a side of the forming plate 33 toward the inner side of the slit 33c to thereby form a groove 33b wider than the slit 33c for defining a configuration of the electrode 1.

In this case, advantageously there is no need for forming the slit previously by way of the electric discharge machining and the width of the slit can be desirably adjusted, as compared to the second embodiment.

### Fourth Embodiment

A fourth embodiment provides a method and an apparatus for forming a microshaft according to “insulated coupling plates”. The “insulating coupling plates” refers to a set of two forming plates used for forming a slit 33c, which is basically similar to that in the third embodiment. However, in the fourth embodiment, one 33d of the forming plates is electrically connected with a discharge machining power supply 5, while the other 33e of the forming plates is electrically insulated from the discharge machining power supply 5, as shown in FIG. 11.

Then, a forming electrode 1 is driven, as in the rotating motion, to scan from a groove end surface 33a side of each of the forming plates 33d, 33e toward an inner side of the slit 33c. During this step, the electric discharge is induced between the forming plate 33d and the electrode 1, so that the forming plate 33d and the electrode 1 are abraded, while on the other hand, no electric discharge is induced between the forming plate 33e and the electrode 1, so that the forming plate 33e and the electrode 1 would be abraded little.

In this case, the side surface of the slit 33c defined in the insulated forming plate 33e would not be subject to the electric discharge machining, and so the electrode 1 can be driven to scan along this side surface.

Further, in the fourth embodiment (FIG. 11), a set of two forming plates may be considered as a single capacitor, where an electrostatic capacity and a groove width between the forming plates are in a proportional relationship. In consideration of the above fact, if the electrostatic capacity of the capacitor is detected by an electrostatic capacity detection means and a servo motor is driven to move the forming plates 33 to achieve an appropriate groove width, then the control of the width of the groove between the forming plates can be provided without visually measuring the groove width.

### Fifth Embodiment

A fifth embodiment provides a method and an apparatus for forming a microshaft according to “up and down scanning”, “orthogonally upward scanning” and “intermittent scanning”. As described with reference to the first embodiment, an electrode 1 can be moved in any desired directions relative to a forming plate 33 with the aid of the stepping motors 12a, 12b and 12c. A secondary motion 50, as will be described below, is a motion applied to the electrode 1 in a direction different from the direction of a primary motion defined by a movement along the scanning direction 7 of the electrode 1.

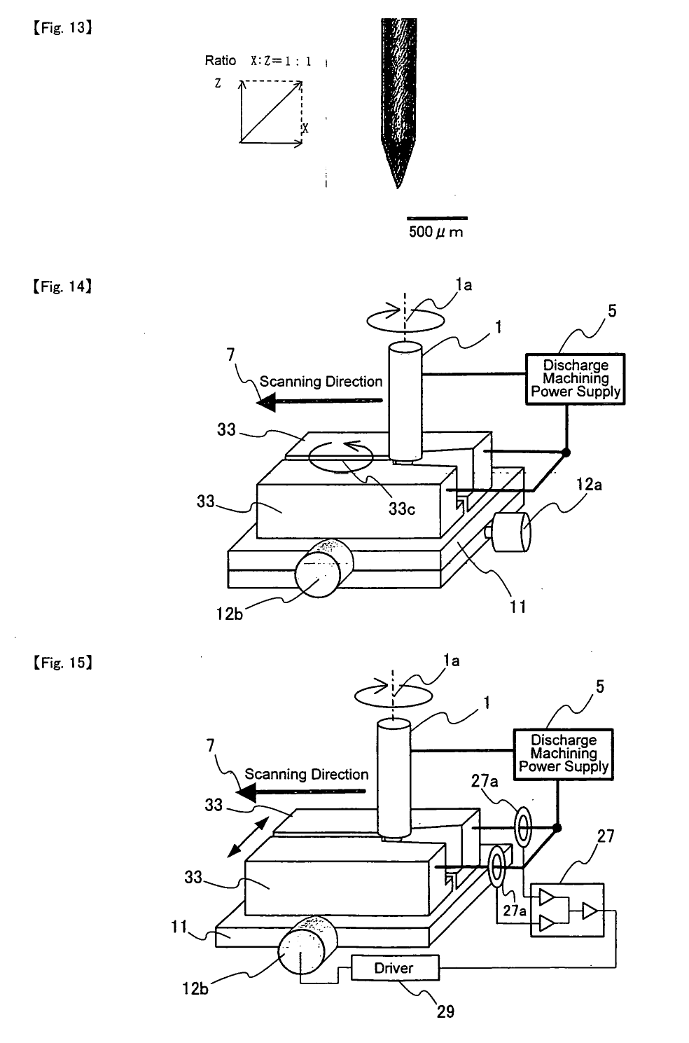

For example, during the horizontal scanning of the electrode 1 as shown in FIG. 12, a secondary motion 50 defined by an up and down reciprocating motion may be applied in a vertical direction with respect to a top surface of the forming plate 33. This can help create a smooth axial profile of the electrode 1. Further, during the scanning of the electrode as shown in FIG. 12, a reciprocating motion of the electrode 1 in the diagonally upward direction with respect to the top surface of the forming plate 33 may be also applied as the secondary motion 50. Such a processing can shape a lower end portion of the electrode 1 into a smooth conical configuration as shown in FIG. 13. In the case as illustrated in FIG. 13, the secondary motion 50 was applied so as to make an elevation angle equal to 45°. In addition, those types of secondary motions 50 may be applied intermittently for scanning.

Although the fifth embodiment (FIG. 12) is achieved by applying the secondary motion 50 to the third embodiment (FIG. 10), this secondary motion 50 is applicable to any one of other embodiments.

### Sixth Embodiment

A sixth embodiment provides a method and an apparatus for forming a microshaft according to a “swing motion”. As shown in FIG. 14, during the scanning of an electrode 1, a swing motion is additionally applied in parallel to a horizontal top surface of a forming plate 33. The swing motion can be achieved by driving a carrier stage 11 so as to make a reciprocating motion appropriately by using stepping motors 12a and 12b.

Although the sixth embodiment (FIG. 12) is achieved by applying the swing motion described above to the third embodiment (FIG. 10), the swing motion is applicable to any one of other embodiments.

### Seventh Embodiment

A seventh embodiment provides a method and an apparatus for forming a microshaft according to “electric discharge frequency difference proportional control”. The “electric discharge frequency difference proportional control” provides the control of the scanning direction 7 of an electrode 1 so that the current flowing to or the electric discharge frequency of the two forming plates 33, which are insulated from each other, may be equal therebetween.

As shown in FIG. 15, connection lines between the forming plates 33 and a discharge machining power supply 5 are provided with current detectors 27a, respectively, for detecting the current flowing to respective forming plates 33. In addition, the current (i.e., the discharge amount) flowing to each of the forming plates is detected by using each current detector 27a. Further, the detected current is compares between respective forming plates in an electric discharge deviation detecting circuit 27, and the stepping motor 12b is driven via a driver 29 so that the current is equal between the forming plates 33 for moving the forming plate 33 in the orthogonal direction with respect to the scanning direction of the electrode 1. This allows the electrode 1 to move always in a central surface of a slit 33c without visually detecting the position of the electrode 1.

It is to be noted that the current flowing to each of the forming plates 33 is proportional to the electric discharge frequency, and the electric discharge frequency is in turn proportional to a distance between a surface of the electrode 1 and a side surface of the forming plate 33 facing to the slit 33c. Accordingly, if the control is provided so that the electric discharge frequency is equal between the two forming plates 33, then the electrode 1 can be driven to scan with the distance between each of the two forming plates 33 and the electrode 1 held equal.

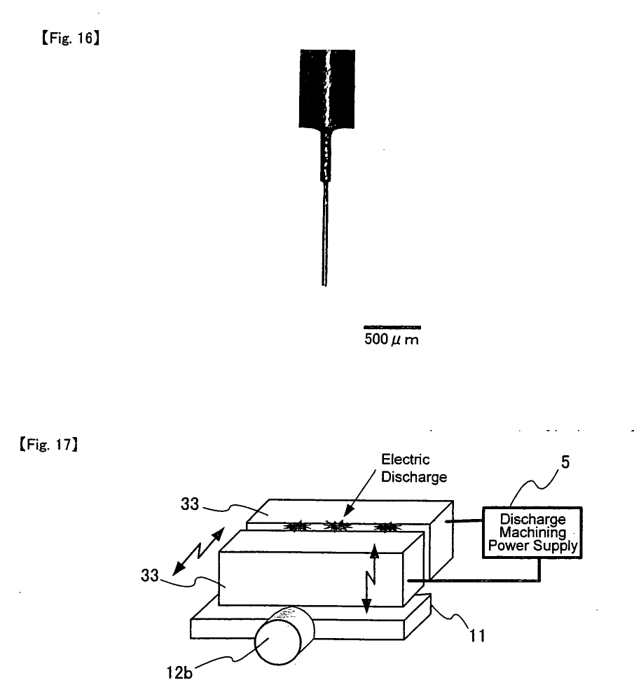

FIG. 16 shows a processed condition of the electrode 1 according to the seventh embodiment. It is to be noted that the electrode shown in FIG. 16 is the one that has been processed into a stepped microshaft by using a cemented carbide as a material for the electrode and a brass as a material for the forming plate. As a result, a microshaft having a tip diameter of 51 micrometer was produced.

### Additional Embodiment

In a first additional embodiment, before the scanning of an electrode 1, two insulated plates are previously applied with a two- or three-dimensional motion to control a groove sectional contour, as shown in FIG. 17. This additional embodiment is provided as a pre-processing in the third embodiment (FIG. 10) for shaping the surfaces of the two forming plates 33 to produce a uniform slit (groove) 33c by performing the electric discharge machining previously between the forming plates 33. Specifically, before the scanning of the electrode 1, on a carrier plate 25, one of the forming plates 33 is applied with a reciprocating motions in the up and down direction and the left and right direction by stepping motors, while at the same time, both of the forming plates 33 are connected to a discharge machining power supply 5 to induce an electric discharge in the slit 33c between the forming plates 33. This allows the both side surfaces of the forming plates 33 facing to the slit 33c to become smooth. If such a smooth slit 33c is used for scanning of the electrode 1, then the electric discharge can be induced uniformly and the microshaft can be shaped with higher precision.

Further, in the first additional embodiment (FIG. 17), an electric discharge frequency during formation of the groove is proportional to a groove width between the forming plates. In consideration of the above fact, if the electric discharge frequency during the formation of the groove is measured by using such a groove width control mechanism as shown in FIG. 15, and based on the measured electric discharge frequency, a groove width measurement is performed and a servo motor is driven to move the forming plates 33 to achieve an appropriate groove width, then the control of the width of the groove between the forming plates can be provided without visually measuring the groove width, as well.

Further, a second additional embodiment provides what is called “slit width control in a repeated scanning” or “repeated scanning” in any one of the first to the seventh embodiments for performing the processing of microshaft formation repeatedly while controlling the groove width. In the second additional embodiment, a servo voltage providing an indication of a discharge electricity condition and a distance between electrodes in each process of the repeatedly performed forming processes may be shifted sequentially to meet the condition for forming a finer shaft.

The second additional embodiment will now be described with reference to FIG. 18. Initially in a first step, an electrode 1 as shown in an upper right location of FIG. 18 is driven to scan in a slit 33c between forming plates 33 for effecting the electric discharge machining. In an upper left location of FIG. 18, there is shown the electrode 1′ having a microshaft 1′b formed through the electric discharge machining in the first step. In a second step, the width of the slit 33c of the forming plates 33 is reduced to produce a narrower slit 33′c and as it is, the electrode 1′ is again driven to scan in the slit 33′c for effecting the electric discharge machining, as shown in a lower right location of FIG. 18. In a lower left location of FIG. 18, there is shown an electrode 1″ having a microshaft formed through the electric discharge machining in the second step. Repeating a step similar to the second step with the narrower slit 33′c results in a narrower microshaft to be produced in the electrode.

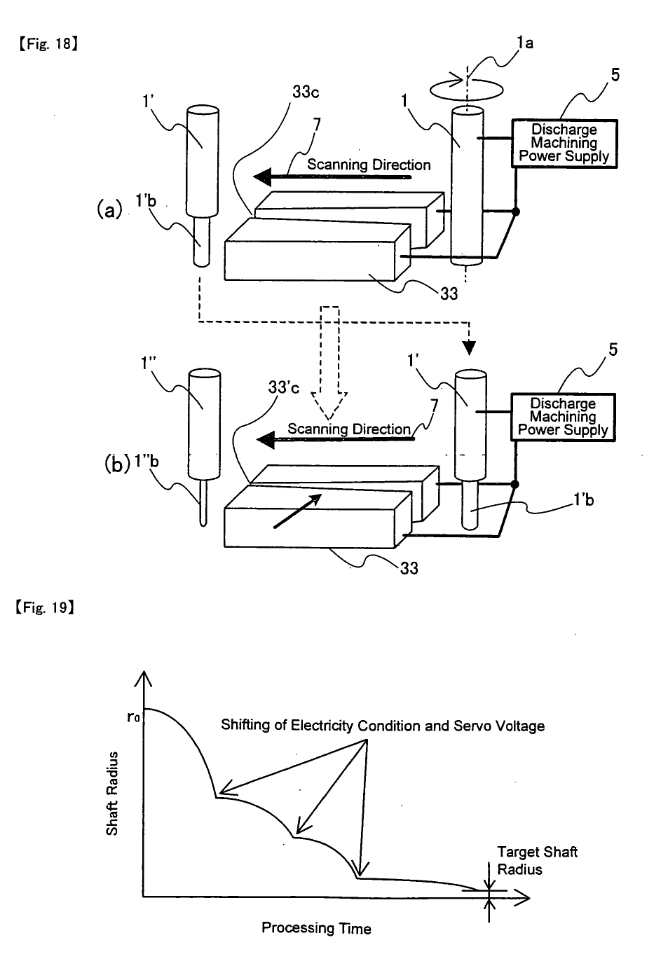

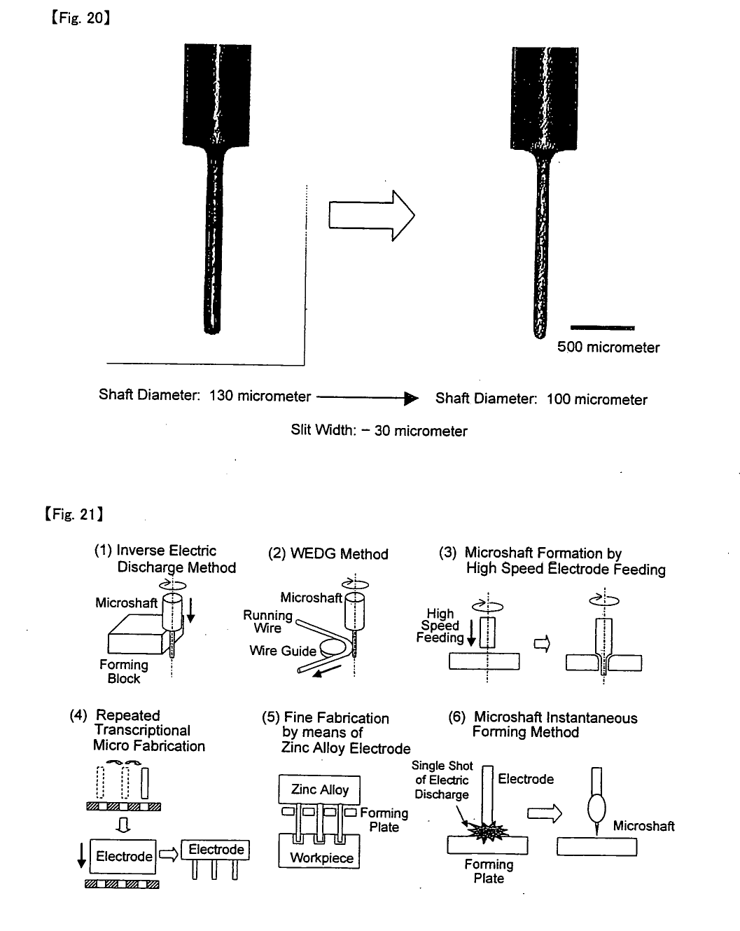

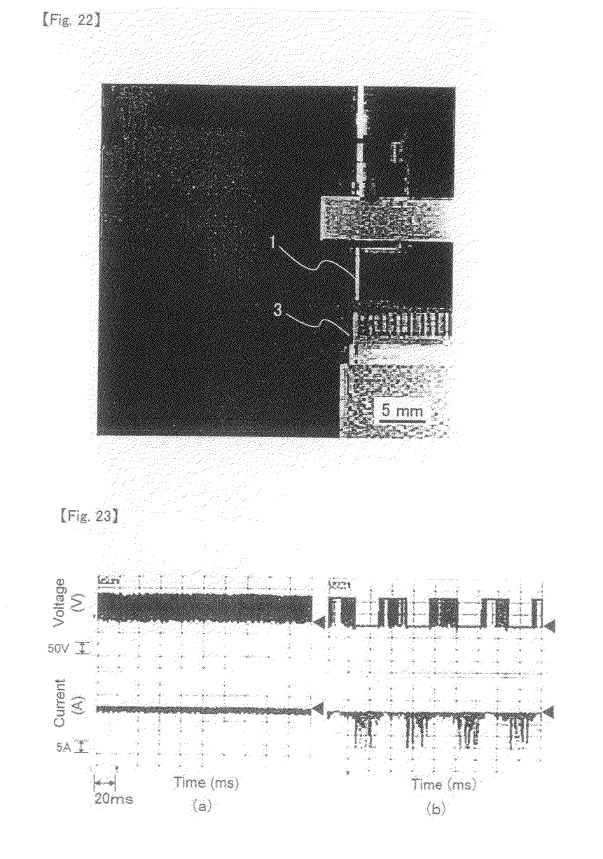

FIG. 19 is a plot with a horizontal axis indicating a processing time and a vertical axis indicating a radius of a shaft of the electrode 1 for a case where the servo voltage is shifted sequentially to meet the condition to produce a finer shaft. In addition, FIG. 20 shows a microshaft formed from the electrode 1 in the second additional embodiment.

It is to be noted that respective embodiments described above may use as a material for the forming plate 3, 33, a less consumable plate, such as a copper-tungsten plate; a consumable plate, such as a silicon plate or a green compact and a semi-sintered compact; and a small work function plate, such as a zinc alloy plate.

Further in any one of the second to the seventh embodiments, instead of the electrode 1, non-conductive shaft may be driven to scan for forming the microshaft. Specifically, when one of a set of two forming plates is used as a conductive coating electrode while the other of the forming plates is used as a shaping electrode and the non-conductive shaft is driven to scan between the two plates, then the non-conductive shaft may be shaped by the electric discharge between the two plates.

According to a method and an apparatus for forming a microshaft of the present invention, since a basic motion (scanning direction 7) is defined to be parallel with a top surface of the forming plate, the electric discharge frequency (a number of electric discharge occurrences as per a unit time) becomes greater, achieving an approximately ideal value. As for a direction orthogonal to the direction for the electrode to be moved, the electric discharge frequency can be made equal between the left and the right with respect to the electrode, so that the effect from the vibration during processing can be reduced and thus a stable electrode shaping can be achieved. In addition, since a rear side with respect to the moving direction of the electrode is cleared, so that an efficiency of removing a processing chips can be improved and consequently a processing time can be shortened.

Further, in the embodiments where the slit (groove) is previously formed in or between the forming plate(s), since a distance determined by subtracting an electric discharge gap (a space between the electrode and the groove inner surfaces) from a slit width defines a final shaft diameter, the electric discharge stops automatically and so there would be no such chance that the shaft is annihilated in the course of processing, and accordingly the control of configuration of the shaft would be extremely easy. In addition, as the shaft diameter for processing becomes finer, inaccuracy between the direction of the slit in the forming plate(s) and the scanning direction 7 of the rotating shaft of the electrode becomes relatively greater, whereas if the two forming plates are disposed, as they are insulated, and a moving control is provided so that the electric discharge frequency is relatively equal with respect to the two forming plates, then the scanning direction and the groove orientation can be held in a parallel relationship. In this case, if the electric discharge machining is performed previously between the two forming plates before the scanning of the electrode, the surfaces of the forming plates opposing to each other within the slit can be completely matched.

Further, if the material for the forming plate employs a material having a lower work function, then the electric discharge may be induced more easily, and with such arrangement, the electric discharge machining operation can be carried out stably even in the case of processing in the air. If a material, such as silicon, is selected as the material for the forming plate, then the surface of the shaft to be formed can be modified to be the one having extremely high corrosion resistance.

It is to be noted that in addition to the respective embodiments as well as the additional embodiments as described above, such a method and an apparatus for carrying out the electric discharge machining operation can be provided that may use a microshaft produced from said electrode 1 as a tool for a subsequent step without any re-chucking operation of the microshaft. Specifically, the forming plate(s) 3, 33 may be removed from the carrier stage 11 without removing the microshaft that has been formed by any one of the respective embodiments as well as the additional embodiments as described above from the electric discharge machining apparatus 9. Subsequently, a new workpiece to be processed is mounted on the carrier stage 11 of the same electric discharge machining apparatus 9, and the microshaft is now used as the tool with respect to the workpiece for forming a fine hole or creating a scanning configuration in the workpiece.

### EXAMPLE 1

This example is directed to modify a surface of a formed microshaft to have extremely high corrosion resistance by selecting silicon as a material for a forming plate.

It has been known that if the finishing electric discharge machining is applied to a steel material by using the silicon as an electrode (forming plate), then a higher processing rate and improved roughness of a processed surface are obtained and no deterioration in the surface roughness is observed even with a larger electrode area, as compared to a copper electrode. In addition, the inventors of the present invention have reported that if the electric discharge machining is applied to the stainless steel by using the silicon as an electrode, a robust layer having corrosion resistance and wear resistance is formed over a surface of a workpiece.

As explained in the embodiments as described above, it has become possible to form a fine linear shaft having a high aspect ratio by carrying out a microshaft formation by means of the scanning electric discharge machining. In this connection, using an apparatus and a method of the above embodiments, the scanning electric discharge machining for microshaft formation was performed with a silicon plate as an electrode (a forming plate) and the research was made with the resultant microshafts on the corrosion resistance, the surface roughness and so on.

### Surface Modification Processing With a Silicon Electrode

In this example, applying the forming method as illustrated in the foregoing embodiments, the scanning electric discharge machining was carried out on the stainless steel (SUS) round bar 1 by using a silicon wafer (thickness of 0.5 mm, specific resistance of 0.02 ohm cm) as an electrode 3 (forming plate). FIG. 22 shows a certain phase of the experiment.

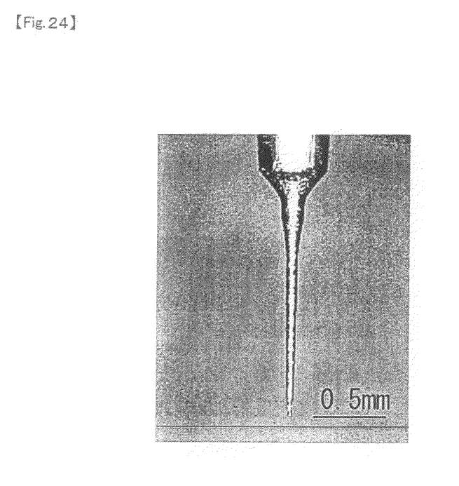

FIG. 23 shows discharge waveforms during the scanning electric discharge machining by using an Si electrode (a forming plate made of Si) and a BS (brass) electrode (a forming plate made of BS). It can be seen from FIG. 23 that in the Si electrode, an affect from offset in an initial stage of the processing was immediately cancelled and a stable electric discharge was obtained, favorably for easy formation of a microshaft, as compared to the case of the BS electrode. Further, a condition employed for the fine linear shaft formation was as follows: an electrode employed Si(−), the peak current Iₚ=1 A, the pulse width (a current duration for a single pulse) τₚ=2 micrometer, the downtime (interval between pulses) τᵣ=16 micrometer, and processing time of 20 minutes and 21 seconds for processing the shaft. As a result, such a fine linear shaft having a tip diameter around 10 micrometer as shown in FIG. 24 was produced.

It is expected that a silicon film should have been formed over the fine linear surface, and if so, it means that the formation of the fine linear shaft having excellent corrosion resistance will become possible. In this viewpoint, a corrosion test by using a hydrochloric acid was performed against the round bar that has been applied with the silicon electrode processing.

### Corrosion Test

It is believed that in the electric discharge machining by way of the silicon electrode, the surface should be covered with a silicon film in the processing time around 5 minutes. In order to confirm that, the condition of a workpiece (round bar made of SUS (stainless steel)) was observed periodically (every one minute). As a result, it was confirmed that even if the eccentricity of the round bar is taken into account, a smooth trace of the electric discharge considered as the silicon film was observed over the outer surface in about 4 minutes, and the surface modification was successfully achieved with the electric discharging for about 5 minutes. The diameter at this point of time was about 400 micrometer. Further, the brass electrode was processed under the same processing condition to achieve the diameter around 400 micrometer, and then those round bars produced from respective electrodes were dipped in a solution of hydrochloric acid (26% concentration) for comparison of the degree of corrosion.

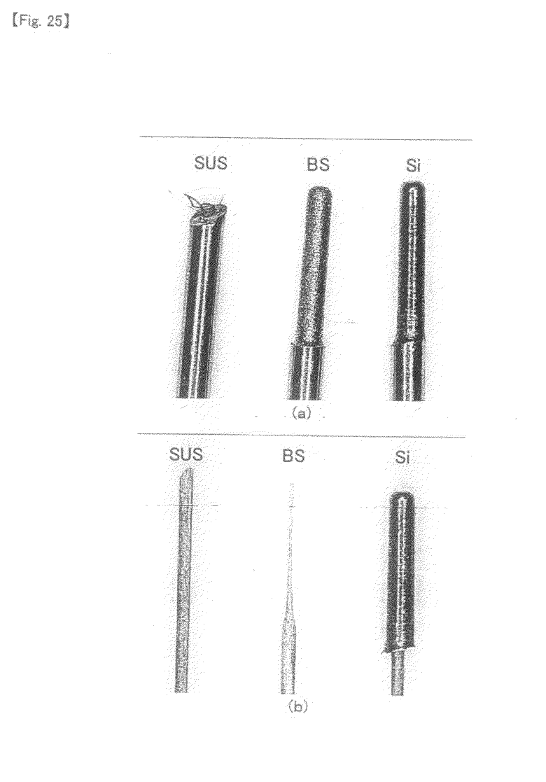

FIG. 25(a) shows a processed site of each round bar after having been processed to the diameter around 400 micrometer by using the BS electrode material and the Si electrode material along with an unprocessed round bar. FIG. 25(b) shows a tip portion of the above workpiece 9-hours after its having been eroded in the hydrochloric acid solution. Proceeding of the corrosion can be observed in both of the unprocessed workpiece and the workpiece that has been processed with the BS electrode. In contrast, the site that has been processed with the Si electrode exhibits no trace of being eroded but the unprocessed portion has became eroded to be much narrower.

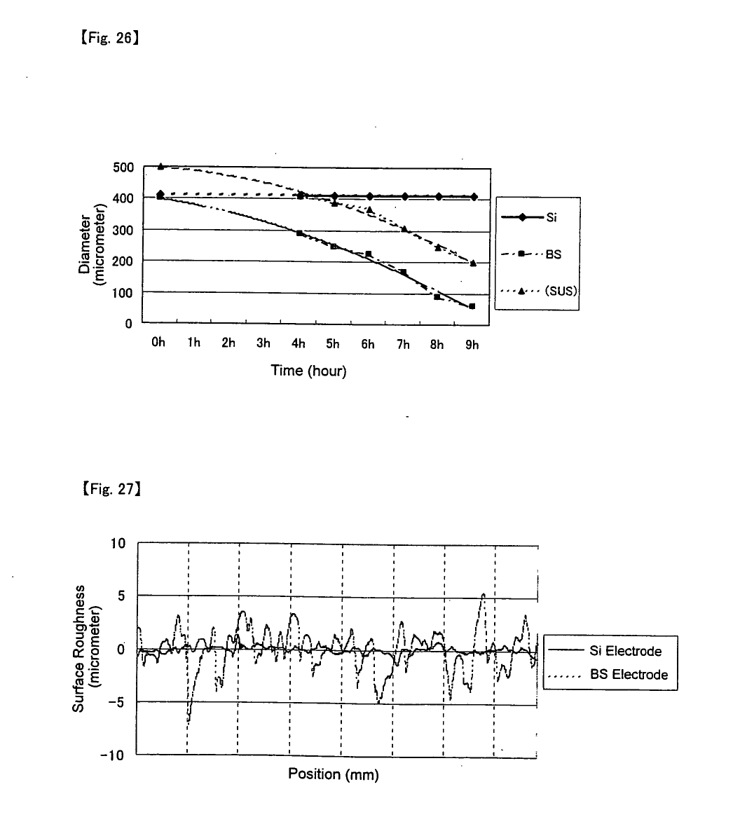

Turning now to FIG. 26, there is shown a transition of shaft diameter as a function of the corrosion time. A decrease in the diameter can be observed over time in both of the unprocessed shaft (the SUS round bar) and the shaft by the BS electrode, while the difference of diameter between the two that has been produced from the electric discharge machining can be maintained. It can be seen on the other hand that the processing applied to the SUS with the Si electrode has achieved the extremely high corrosion resistance even in the microshaft formation.

### Surface Roughness Measurement

In the observation with a microscope, the surface processed with the Si electrode is seen much smoother than that processed with the BS electrode. In this regard, the surface roughness measurement was carried out by using a confocal three-dimensional microscope and a surface roughness meter.

The surface roughness profile for each of the two is shown in FIG. 27. The site processed with the Si electrode exhibits much smoother surface feature (0.25 micrometer, Ra) than that processed with the BS electrode (1.5 micrometer, Ra).

### SEM Image, EDS Analysis

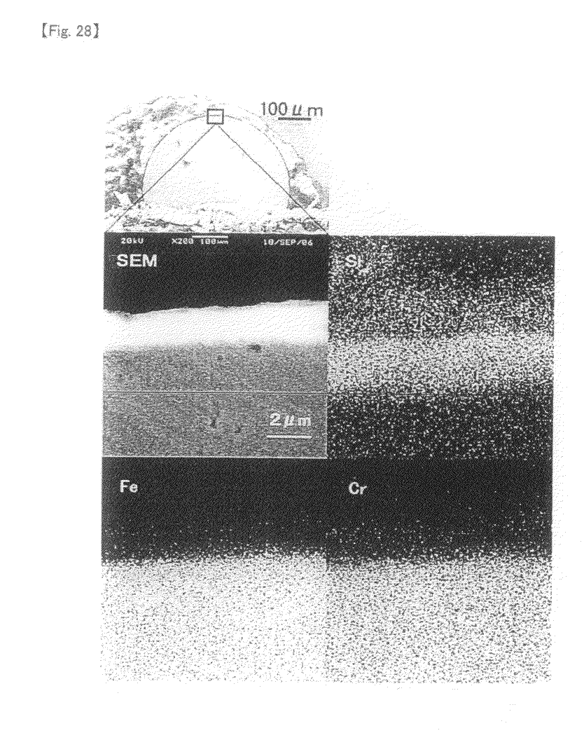

Observations by means of a SEM (Scanning Electron Microscope) and an EDS (Energy Dispersive X-ray Spectroscopy) were carried out on the round bar having its surface modified through the electric discharge machining carried out by using the Si electrode. FIG. 28 shows an analysis result of Si, Fe and Cr from the SEM image and the EDS analysis on a section of the round bar.

It can be seen from the EDS analysis that the Si (or a compound containing Si) is placed over the workpiece surface. In addition, it can be confirmed from the SEM image that the thickness of the film was some micrometer.

To summarize the foregoing description, in the illustrated embodiment, the electric discharge machining was carried out by using the silicon as the electrode (the forming plate) and the microshaft was successfully formed. Thus the formed microshaft had obtained the corrosion resistance and the improved surface roughness, actually much smoother than a typical processed surface by the electric discharge machining. Since the silicon film formed over the workpiece surface was not eroded even by the hydrochloric acid, therefore it is believed that this can be possibly useful for an application, such as a scanning probe or a handling tool in a corrosive environment.

1. A method for forming a microshaft, comprising:
a step of providing an electrode to be processed into said microshaft;
a step of providing a forming member for shaping said electrode;
an electrode rotation step for rotating said electrode around a rotation center extending longitudinally through said electrode;
a power supplying step for supplying a power to said electrode and to said forming member by using a discharge machining power supply in order to induce electric discharge between said electrode and said forming member;
an electrode moving step for moving said electrode, as it is in a rotational motion by said electrode rotation step, from a lateral end side of said forming member transversely across said forming member; and
a microshaft formation step for shaping said electrode to be formed into said microshaft, while forming a groove in said forming member during said electrode moving step by using the electric discharge induced between said electrode and said forming member by said power supplying step.

2. A method for forming a microshaft in accordance with claim 1, further comprising, before said electrode moving step, a slit formation step for forming a slit previously in said forming member along a direction for said electrode to be moved.

3. A method for forming a microshaft in accordance with claim 2, wherein said forming member comprises two forming members and said slit is formed as a gap between said two forming members.

4. A method for forming a microshaft in accordance with claim 3, wherein said two forming members are electrically isolated from each other.

5. A method for forming a microshaft in accordance with claim 3, wherein said two forming members are electrically connected with each other.

6. A method for forming a microshaft in accordance with claim 1, wherein
during said electrode moving step, a secondary motion is applied to said electrode in a direction different from the direction of said electrode moving from said lateral end side of said forming member transversely across said forming member.

7. A method for forming a microshaft in accordance with claim 6, wherein
said secondary motion is a reciprocating motion of said electrode in a direction vertical to a top surface of said forming member.

8. A method for forming a microshaft in accordance with claim 6, wherein
said secondary motion is a reciprocating motion of said electrode in an angled direction relative to a top surface of said forming member.

9. A method for forming a microshaft in accordance with claim 1, wherein
during said electrode movement step, said electrode is driven to make a swing motion relative to said forming member in a direction parallel to a top surface of said forming member.

10. A method for forming a microshaft in accordance with claim 3, further comprising:
a discharge frequency measurement step for measuring discharge frequencies between said electrode and each of said two forming members; and
a discharge frequency control step for controlling said discharge frequencies measured in said discharge frequency measurement step so that said discharge frequencies are equal to each other.

11. A method for forming a microshaft in accordance with claim 10, wherein
said discharge frequency control step comprises a distance control means for controlling distances between each of said two forming members and said electrode to be equal to each other.

12. A method for forming a microshaft in accordance with claim 10, wherein
said discharge frequency measurement step is a current detection step for detecting current flowing to each of said two forming members.

13. A method for forming a microshaft in accordance with claim 3, further comprising:
before said electrode moving step, a slit discharge machining step for performing previously the electric discharge machining between said two forming members so as to shape an inner surface of said slit.

14. A method for forming a microshaft in accordance with claim 1, further comprising:
after said microshaft formation step, a groove width adjustment step for narrowing said groove of said forming member; and
after said groove width adjustment step, a reprocessing step for performing a series of operations comprising said electrode rotation step, said power supplying step, said electrode moving step and said microshaft formation step in a sequential manner.

15. A method for forming a microshaft in accordance with claim 14, wherein
said reprocessing step is repeated by multiple times.

16. A microshaft comprising
a microshaft is formed from an electrode by using a method for forming a microshaft in accordance with said claim.

17. An apparatus for forming a microshaft, comprising:
an electrode to be processed into said microshaft;
a forming member for shaping said electrode;
an electrode rotation means for rotating said electrode around a rotation center extending longitudinally through said electrode;
a discharge machining power supply for supplying power to said electrode and to said forming member in order to induce electric discharge between said electrode and said forming member; and
an electrode moving means for moving said electrode, as it is in a rotational motion driven by said electrode rotation means, from a lateral end side of said forming member transversely across said forming member, wherein
during operation of said electrode moving means, said electrode is shaped to form said microshaft while forming a groove in said forming member by using the electric discharge induced between said electrode and said forming member by said discharge machining power supply.

18. An apparatus for forming a microshaft in accordance with claim 17, wherein
said forming member comprises a slit that is previously formed in said forming member along a direction for said electrode to be moved.

19. An apparatus for forming a microshaft in accordance with claim 18, wherein said forming member comprises two forming members and said slit is formed as a gap between said two forming members.

20. An apparatus for forming a microshaft in accordance with claim 19, further comprising
a frequency measurement means for measuring discharge frequencies between said electrode and each of said two forming members; and
a discharge frequency control means for controlling said discharge frequencies measured by said discharge frequency measurement means so that said discharge frequencies are equal to each other.

21. A method for forming a microshaft in accordance with claim 1, wherein said forming member employs a forming member made of silicon.

22. A method for forming a microshaft in accordance with claim 21, wherein
electric discharge is induced between said electrode and said forming member made of silicon, so that a silicon contained layer is formed over a surface of said microshaft, while said microshaft is being formed.

23. A microshaft comprising a silicon contained layer formed over a surface of the microshaft by a method for forming a microshaft in accordance with claim 21.

24. A method for forming a microshaft in accordance with claim 10, further comprising:
before said electrode moving step, a slit discharge machining step for performing previously the electric discharge machining between said two forming members so as to shape an inner surface of said slit.
